(19) United States
(12) Patent Application Publication
(10) Pub. No.: US 2022/0375163 A1
(43) Pub. Date: Nov. 24, 2022

(54) Computationally-Efficient Generation of Simulations of Cloth-Like Materials Using Bilinear Element Models

(71) Applicant: Unity Technologies SF, San Francisco, CA (US)

(72) Inventors: Eston Schweickart, Wellington (NZ); Xiao Zhai, Wellington (NZ)

(21) Appl. No.: 17/321,211

(22) Filed: May 14, 2021

(51) Int. Cl. G06T 17/20; G06T 13/20

(52) U.S. Cl. CPC G06T 17/20; G06T 13/20; G06T 2210/16

(57) ABSTRACT

A computer implemented method simulates a flexible material. The method includes representing the flexible material with a mesh that includes bilinear quadrilateral mesh elements with a specified number of degrees of freedom per vertex. The method also includes computing a per-element deformation strain value for the mesh elements, wherein deformation strain values depend on a second order function with respect to the degrees of freedom of the vertices of the mesh elements. The method also includes simulating motion of the flexible material using the deformation strains of each mesh element to simulate motion of the vertices along the specified number degrees of freedom.

### FIELD

The subject matter described herein relates to a computer-implemented method for simulating cloth. This cloth simulation method has particular but not exclusive utility for computer graphics and animation.

### BACKGROUND

For visual effects and animation, the geometry used for cloth simulations is often subject to topology requirements from other stages of the production pipeline. Requests to simulate quadrilateral meshes are common, as these topologies are beneficial for modelling, subdivision, and rendering. However, most cloth simulation algorithms are defined only for triangular meshes (e.g., meshes comprising a plurality of triangles). Quadrilaterals may be split into triangles, or the input geometry may be re-meshed, but the output simulated mesh must have the same topology as the input in the production pipeline. This means the triangle displacements must be mapped back to the original mesh, which can lead to faceting and tent-like artifacts from artificial curvature induced by the mapping.

Additionally, it is not uncommon to find quadrilateral mesh structures in so-called mass-spring cloth models. These show up from time to time in computer graphics applications, especially in older publications. However, it is widely accepted that these methods cannot correctly capture the way the material reacts to shearing deformations.

It is to be appreciated that such commonly used methods for rendering cloth have numerous drawbacks, including faceting, tenting, improper shear deformation, and otherwise. Accordingly, a need exists for improved cloth simulation methods that address the foregoing and other concerns.

### REFERENCES

Fernando De Goes, Andrew Butts, and Mathieu Desbrun. 2020. Discrete differential operators on polygonal meshes. ACM Transactions on Graphics (TOG) 39, 4 (2020), 110-1.
Pascal Volino, Nadia Magnenat-Thalmann, and Francois Faure. 2009. A simple approach to nonlinear tensile stiffness for accurate cloth simulation. ACM Transactions on Graphics 28, 4, Article 105 (2009).
David E Breen, Donald H House, and Michael J Wozny. 1994. Predicting the drape of woven cloth using interacting particles. In Proceedings of the 21st annual conference on Computer graphics and interactive techniques. 365-372.
Ke-Yang Dai, Gui-Rong Liu, and Thoi-Trung Nguyen. 2007. An n-sided polygonal smoothed finite element method (nSFEM) for solid mechanics Finite elements in analysis and design 43, 11-12 (2007), 847-860.
Fernando De Goes, Andrew Butts, and Mathieu Desbrun. 2020. Discrete differential operators on polygonal meshes. ACM Transactions on Graphics (TOG) 39, 4 (2020), 110-1.
Friedrich Gruttmann and Werner Wagner. 2005. A linear quadrilateral shell element with fast stiffness computation. Computer Methods in Applied Mechanics and Engineering 194, 39-41 (2005), 4279-4300.
W T Koiter. 1960. A consistent first approximation in the general theory of thin elastic shells. The theory of thin elastic shells (1960), 12-33.
Pascal Volino, Nadia Magnenat-Thalmann, and Francois Faure. 2009. A simple approach to nonlinear tensile stiffness for accurate cloth simulation. ACM Transactions on Graphics 28, 4, Article 105 (2009).
Denis Zorin. 2005. Curvature-based energy for simulation and variational modeling. In International Conference on Shape Modeling and Applications 2005 (SMI'05). IEEE, 196-204.

The information included in this Background section of the specification, including any references cited herein and any description or discussion thereof, is included for technical reference purposes only and is not to be regarded as subject matter by which the scope of the disclosure is to be bound.

### SUMMARY

Many cloth simulation algorithms within the computer graphics community are defined exclusively for triangular meshes. However, production assets are often made up of non-planar quadrilaterals. Dividing these elements into triangles and then mapping the displacements back to the original mesh results in faceting, tenting, and other artifacts when the quadrilaterals are rendered as bilinear patches. Disclosed herein is a novel cloth simulation method that simulates cloth dynamics on quadrilateral meshes directly, drawing on a thin sheet model to define elastic energies. The algorithm avoids artifact-prone geometric mapping, with a minimal increase in computation.

The method improves simulation of shearing effects as compared with mass-spring systems. Some past methods have also used quadrilateral mesh faces to simulate cloth dynamics, while making a number of restrictive assumptions, such as requiring the entire mesh to be comprised of quadrilaterals and requiring mesh edges to align with the weave directions of the cloth. The present cloth simulation method avoids these limitations, and also supports anisotropic stretching stiffness, while supplying a positive definite energy Hessian for robust implicit integration.

The cloth simulation method disclosed herein has particular, but not exclusive, utility for computer graphic visual effects and animation. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer implemented method for simulating a flexible material. The computer implemented method includes generating a mesh data structure representing the flexible material with a mesh, the mesh including at least one bilinear quadrilateral mesh element; generating a vertex data structure representing vertices of the at least one bilinear quadrilateral mesh element with the vertex data structure specifying a specified number of degrees of freedom per vertex; computing a per-element deformation strain value for at least one bilinear quadrilateral mesh element of the at least one quadrilinear mesh element, where the per-element deformation strain value depends on a second order function with respect to the specified number of degrees of freedom of vertices of the at least one bilinear quadrilateral mesh element; and simulating a motion of the flexible material using at least per-element deformation stresses of each mesh element of the mesh to simulate motion of the vertices of mesh elements along the specified number degrees of freedom of their respective vertices. Other embodiments of this aspect include corresponding computer systems, apparatus, and computer programs recorded on one or more computer storage devices or media, each configured to perform the actions of the methods.

Implementations may include one or more of the following features. In some embodiments, the specified number of degrees of freedom per vertex is three. In some embodiments, the mesh includes no more than one quadrature point per mesh element. In some embodiments, edge orientations of the at least one quadrilateral mesh element and the at least one triangular mesh element are independent of a substructure of the flexible material. In some embodiments, at least one bilinear quadrilateral mesh element of the at least one bilinear quadrilateral mesh element is non-planar. In some embodiments, the mesh additionally includes at least one triangular mesh element. In some embodiments, the second mesh represents a non-planar rest state of the flexible material. In some embodiments, the per-element deformation strains represent an anisotropic stiffness of the material. In some embodiments, the anisotropic stiffness increases monotonically with a bend angle (or as a function of the per-element deformation strains) and has no negative derivative anywhere on the mesh. In some embodiments, simulating the motion of the flexible material includes simulating viscous damping of the motion. In some embodiments, the mesh represents an artist-developed topology of the flexible material. In some embodiments, the mesh is configured to be rendered without remeshing to a mesh including only triangular mesh elements. In some embodiments, the mesh is associated with a positive definite energy Hessian. In some embodiments, a deformation energy of the mesh includes: a membrane deformation energy including in-plane stretch energy and in-plane and shear energy; and a bending deformation energy including in-element bending energies and cross-element bending energies for each mesh element. In some embodiments, the deformation energy of the mesh further includes gradients of the membrane deformation energy and bending deformation energy. In some embodiments, a thickness of the flexible material is less than 5% of a length and breadth of the flexible material. In some embodiments, the thickness of the flexible material is constant. In some embodiments, the flexible material includes cloth, paper, rubber, plastic, feathers, or leaves. Implementations of the described techniques may include hardware, a method or process, or computer software on a computer-accessible medium.

One general aspect includes a computer implemented method for simulating a flexible material. The computer implemented method includes generating a mesh data structure representing the flexible material with a mesh including at least one non-planar bilinear quadrilateral mesh element, where each mesh element of the at least one non-planar bilinear quadrilateral mesh element includes a single quadrature point and no additional quadrature points; generating a vertex data structure representing the vertices of the at least one quadrilateral mesh element with no more than three degrees of freedom per vertex; computing a deformation strain value that is second order with respect to the degrees of freedom of the vertices of each mesh element, and simulating motion of the cloth by simulating motion of vertices of each mesh element along the three degrees of freedom of the respective vertex. Other embodiments of this aspect include corresponding computer systems, apparatus, and computer programs recorded on one or more computer storage devices, each configured to perform the actions of the methods, or pixel information generated according to the methods described herein. Other embodiments of this aspect include corresponding computer systems, apparatus, and computer programs recorded on one or more computer storage devices, each configured to perform the actions of the methods.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the cloth simulation method, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic view, in block diagram form, of a simulation system, in accordance with at least one embodiment of the present disclosure.

FIG. 2 shows a simplified exemplary process for simulating a piece of cloth, according to aspects of the present disclosure.

FIG. 3A is an exemplary perspective view and side view representation of a piece of cloth simulated via the process described in FIG. 2, or an equivalent process, according to aspects of the present disclosure.

FIG. 3B is an exemplary perspective view and side view representation of a piece of cloth simulated according to at least one embodiment of the present disclosure.

FIG. 4 is an exemplary perspective view of a piece of cloth simulated via the process described in FIG. 2, or an equivalent process, according to aspects of the present disclosure.

FIG. 5 is an exemplary perspective view of a piece of cloth simulated according to at least one embodiment of the present disclosure.

FIG. 6 illustrates an example visual content generation system as might be used to generate imagery in the form of still images and/or video sequences of images, such as a cloth simulation system to provide for visually appealing simulations, in accordance with at least one embodiment of the present disclosure.

FIG. 7 is a block diagram illustrating an example computer system upon which computer systems of the systems illustrated in FIGS. 1 and 6 may be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Many cloth simulation algorithms within the computer graphics community are defined exclusively for triangular meshes (e.g., meshes comprising a plurality of triangles). However, assets used in production (e.g., simulated cloth objects draped over characters or other objects) are often made up of non-planar quadrilaterals. Dividing these elements into triangles and then mapping the displacements back to the original mesh results in faceting, tenting, and other artifacts when the quadrilaterals are rendered as bilinear patches. Disclosed herein is a novel cloth simulation method that simulates cloth dynamics on quadrilateral meshes directly, drawing on the Koiter thin sheet model [Koiter 1960] to define consistent elastic energies for linear and bilinear elements. The algorithm of the cloth simulation method elides the need for artifact-prone geometric mapping, and yet has computation times similar to its fully triangular counterpart.

Compared with previous cloth simulation methods such as mass-spring systems, the method of the present disclosure provides advantageous improvements in capturing shearing effects. Some past methods have also used quadrilateral mesh faces to simulate cloth dynamics. However, such methods make a number of restrictive assumptions that limit the kinds of geometries they are able to simulate. For example, such methods are only valid if the entire mesh is comprised of quadrilaterals. By contrast, the method disclosed herein can simulate cloth models that contain both triangles and quadrilaterals. In addition, older algorithms require that mesh edges align with the warp or weft direction of the cloth, which can present significant limitations. Conversely, the method disclosed herein has no restriction on the orientation of the faces relative to the yarn direction.

By simulating the same geometric primitive that will later be rendered, the cloth simulation method of the present disclosure greatly reduces the risk of introducing artifacts through geometric mapping. The method is advantageously configured to work in demanding environments, and its elastic energies are compatible with both triangles and quadrilaterals. The method supports anisotropic stretching stiffness, and supplies a positive definite energy Hessian for robust implicit integration. However, the method is not significantly more computationally expensive that simulating an equivalent all-triangle mesh. Thus, the advantages of the present disclosure can be attained at minimal additional cost over triangular mesh simulations.

Breen et al. [Breen 1994] previously described how to simulate cloth on regular quadrilateral meshes. In fact, in other fields, simulating thin shells with quadrilateral elements is quite common; see for instance [Dai et al. 2007] and [Gruttmann and Wagner 2005]. However, unlike our algorithm, these methods commonly increase the number of degrees of freedom, require multiple quadrature points per element, or do not support features that are important to a digital animation pipeline such as anisotropic stiffness or a non-planar rest state. By contrast, the cloth simulation method of the present disclosure does not increase the number of degrees of freedom, does not require multiple quadrature points per element, and permits both anisotropic stiffness (e.g., tension) within the cloth, and allows for a non-planar rest state for the elements.

The methods of the present disclosure can be applied to any thin, flexible material, including but not limited to cloth, paper, rubber, plastic, feathers, or leaves. In this context, “thin” means that one dimension of the material is substantially smaller (e.g., less than 5% the size) of the other two dimensions, such that any bulging properties of the thin dimension are not apparent to the eye. Thus, there is no visual impact from an assumption or constraint (made by some embodiments) that the material is of constant thickness. In some embodiments, the material is modeled such that its stiffness increases monotonically and gradually with bend angle (or as a function of the per-element deformation strains), and does not exhibit any negative derivatives. The present method can support mixed meshes comprising both triangles and quadrilaterals, and allows for embodiments with just three degrees of freedom per vertex, and a single quadrature point per mesh element.

The present disclosure aids substantially in the simulation of clothing and other cloth goods, by improving the realism of the cloth's simulated shape and motion as it bends in relation to other objects. Implemented on a processor in communication with an animation system, the cloth simulation method disclosed herein provides practical improvement in the modeling of draped and bent fabrics. This improved cloth modeling can transform a rendering with prominent meshing artifacts into one with few or no visible artifacts, without the normally routine need to decrease the mesh size (and thus increase the computational burden) or have an artist correct the models or their outputs. This unconventional approach improves the functioning of the animation system, by allowing the creation of higher-fidelity images without substantially more computing time.

The cloth simulation method may be implemented as a process with outputs viewable on a display, and operated by a control process executing on a processor that accepts user inputs from a keyboard, mouse, or touchscreen interface, and that is in communication with one or more data storage elements. In that regard, the control process performs certain specific operations in response to different inputs or selections made at different times. Certain structures, functions, and operations of the processor, display, sensors, and user input systems are known in the art, while others are recited herein to enable novel features or aspects of the present disclosure with particularity.

These descriptions are provided for exemplary purposes only and should not be considered to limit the scope of the cloth simulation method. Certain features may be added, removed, or modified without departing from the spirit of the claimed subject matter.

### Cloth Deformation Model

An image processor that is to use or simulate cloth or similar material processes an input data structure where the input data structure defines a manifold mesh comprising quadrilaterals and triangles, specifically at least one quadrilateral and at least one triangle in a particular embodiment. Another input, which can be optional, is a rest state mesh data structure that represents an equivalent topology of a cloth's rest state. The rest state might be the cloth having position and orientation details of some base mesh of the cloth, possibly arranged without reference to internal and/or external forces. Yet another possible input is a vertex data structure specifying uv coordinates for each vertex, which can encode orientation of a material space while its scale can be defined by the rest mesh. We interpret each quadrilateral as a bilinear patch, which is the simplest surface defined by 4 points. Given the positions of the vertices of the element p₀ . . . p₃ ordered counterclockwise, an image processor can process the patch according to Equation 1, where s and t are in [0,1]².

p(s,t)=(1−s)(1−t)p₀+(s)(1−t)p₁+(s)(t)p₂+(1−s)(t)p₃ Eqn. 1:

The tangents

$$\frac{\partial p}{\partial s} ( t ) and \frac{\partial p}{\partial t} ( s ) ,$$

can be computed, as well as the tangent gradient

$$\frac{{\partial }^{2} p}{\partial s \partial t} ,$$

which is constant over the patch. Similarly, we can define mappings from this st-parameter space to the rest mesh and to uv-space.

As is typical in simulations of thin shells, we assume that the deformation energy of our mesh can be decomposed into the sum of membrane (in-plane) and bending (out-of-plane) components. We consider each of these modes individually in the following sections.

### Membrane Deformation Energy

There are many well known membrane energy models for thin shells. In our system, we use the method proposed by Volino et al. [Volino 2009]. In this framework, strains are calculated by constructing a deformation gradient F of the mapping from 2D material space into 3D world space for each element. The Voigt form of the resulting St. Venant-Kirchhoff strain tensor is a vector εₘ∈ [symbol] ³:

ε_{M}=Voigt(½(F^{T}F−I)) Eqn. 2

The entries of this vector measure stretch along the u-axis, stretch along the v-axis, and in-plane shear respectively. This is then used to define the membrane deformation energy as in Equation 3, where h is the (constant) thickness of the cloth, Ω̅, is the rest surface with area element Ā, and K is the 3×3 stiffness matrix.

$${E}_{m} = \frac{h}{2} {\int }_{\overline{Ω}} {ε}_{m}^{T} K {ε}_{m} d \overline{A} \qquad Eqn . 3$$

Since εₘ is constant over planar elements, the integral can be calculated easily for triangles, but we need a way to compute it for bilinear patches. One option is to approximate the integral in Equation 3 using Gaussian quadrature at the cost of computing strain values at multiple points on the patch. However, because the strains are quadratic in our degrees of freedom, and because tangents vary linearly over the patch, we can express the sum of quadratures as a linear combination of 7 values which depend only on

$$\frac{\partial p}{\partial s} ( \frac{1}{2} ) , \frac{\partial p}{\partial t} ( \frac{1}{2} ) , and \frac{{\partial }^{2} p}{\partial s \partial t} .$$

This means that we can approximate Equation 3 to arbitrary precision while computing just seven strain values at runtime. Collecting these new strain definitions into a new strain vector \hat{ε}ₘ, we can approximate Equation 3 for quadrilaterals as in Equation 4, where Q is the set of quadrilateral faces, and \hat{K}_{q} is a 7×7 modified stiffness matrix that can be precomputed for every bilinear element and accounts for the quadrature weights and rest area.

$${E}_{m} \approx \frac{h}{2} {\sum }_{q ∈ Q} {\hat{ε}}_{m}^{T} {\hat{K}}_{q} {\hat{ε}}_{m} \qquad Eqn . 4$$

Another benefit of using a quadratic strain measure is that the energy Hessian is constant per element, meaning it can be trivially projected to be positive semi-definite by analytically computing its eigen-decomposition. This ensures that Newton's method can be reliably used for implicit integration.

### Bending Deformation Energy

When calculating the bending energy of a mesh composed of non-planar elements, we must consider the bending deformations both within individual elements and between neighboring elements. We consider each of these deformations individually.

### In-Element Bending

We use differential geometry to measure the curvature of each bilinear element. From the first and second fundamental forms, we can construct the shape operator, which is a linear operator (in our case, a 2×2 matrix) that describes how the normal changes at a point on a surface when moving along a particular direction in the tangent space. A common bending strain is the mean curvature, equal to the trace of the shape operator. However, this measure is often 0 at the center of bilinear patches, so we would need several quadrature points to integrate this strain over the element accurately. As an alternative, we propose a more general bending energy first described by Koiter [Koiter 1960]. This energy can be formulated as in Equation 5, where S and S̅ are the shape operators of the current and rest surfaces respectively, and k₁ and k₂ are stiffness measures that can be derived from the entries of K.

$${E}_{b} = \frac{{h}^{3}}{48} {\int }_{\overline{Ω}} {k}_{1} T {r ( S - \overline{S} )}^{2} + {k}_{2} T r ( {( S - \overline{S} )}^{2} ) d \overline{A} \qquad Eqn . 5$$

The first term measures mean curvature, and the second term accounts for the Gaussian curvature. We have found that using a single quadrature point at the center of the patch is a sufficient approximation of Equation 5.

### Cross-Element Bending.

There are multiple ways to calculate the shape operator for discrete meshes, though fewer options are applicable to non-triangular meshes. We use the adjoint shape operator definition in [De Goes et al. 2020], which calculates a discrete shape operator at a vertex from the normals of the adjacent faces. The operator is most accurate for regularly arranged quads, which is commonly our input. For bilinear patches, we use the normal at the center of the patch, which is consistent with how normals are defined for quadrilaterals in [De Goes et al. 2020]. This also ensures that the in-element and cross-element energies are disjoint. For consistency with the in-element energy, we use this discrete shape operator to calculate Equation 5, now summed over all vertices.

### Derivation of Membrane Energy

In the following section, we describe a membrane deformation energy based on [Volino et al. 2009] that is consistent for both triangle elements and bilinear elements. The following section assumes we have an isotropic stretching model; an anisotropic extension is discussed below.

Following [Volino et al. 2009], we assume that we have a mapping from a 2D material space to 3D world space for each element. From this mapping, we can calculate a 3×2 deformation gradient F:

F=[U|V] Eqn. 6

The authors describe how to compute U, V∈ [symbol] ³ from the positions of the vertices of each triangle as well as material space coordinates. We make a slight modification: we assume that we have a rest mesh in world space, which is more convenient for artists to specify. Let pᵢ be the world space positions of an element, with corresponding rest positions p̅ᵢ, where i∈[0,1,2] if the element is a triangle or i∈[0,1,2,3] if the element is a quadrilateral. In the latter case, we define the associated bilinear element as:

p(s,t)=(1−s)(1−t)p₀+(s)(1−t)p₁+(s)(t)p₂+(1−s)(t)p₃ Eqn. 7

To construct a deformation gradient between rest space and world space, we find a mapping between the associated tangent spaces. We first define linear bases for each tangent space, represented by 3×2 matrices T and T̅. For triangles, an image processor can compute and/or define triangles as in Equation 8 and similarly for T̅.

T=[(p₁−p₀)|(p₂−p₀)] Eqn. 8

For bilinear elements, a natural choice is as shown in Equation 9 and similarly for T̅(s, t).

$$T ( s , t ) = [ \frac{\partial p}{\partial s} ( t ) \vert \frac{\partial p}{\partial t} ( s ) ] \qquad Eqn . 9$$

In either case, we can define the deformation gradient between the spaces as in Equation 10, where Q̅R̅=T̅ is the thin QR-decomposition of the rest tangent space matrix, i.e., R̅⁻¹ is a lower-triangular 2×2 matrix that orthonormalizes the rest tangent frame.

F=[U|V]=TR̅⁻¹ Eqn. 10

With these definitions, we return to the membrane deformation energy as illustrated in Equation 11, where h is the shell thickness, Ω̅ is the rest surface with area element Ā, εₘ is the membrane strain, and K is a stiffness matrix.

$${E}_{m} = \frac{h}{2} {\int }_{\overline{Ω}} {ε}_{m}^{T} K {ε}_{m} d \overline{A} \qquad Eqn . 11$$

Following the linear thin shell model, K can be defined from Young's Modulus E and Poisson's Ratio v as follows:

$$K = \frac{E}{1 - {v}^{2}} [ \begin{matrix}1 & v & 0 \\ v & 1 & 0 \\ 0 & 0 & \frac{1 - v}{2}\end{matrix} ] \qquad Eqn . 12$$

We define εₘ to be the Voigt form of the St. Venant-Kirchhoff strain tensor:

$${ε}_{m} = V oigt ( \frac{1}{2} ( {F}^{T} F - I ) ) = [ \begin{matrix}\frac{1}{2} ( {U}^{T} U - 1 ) \\ \frac{1}{2} ( {V}^{T} V - 1 ) \\ {U}^{T} V\end{matrix} ] \qquad Eqn . 13$$

This is straightforward to evaluate for linear surface elements with constant deformation gradients, but εₘ varies over a bilinear patch. In this case, we can instead approximate the energy over these faces using the Gaussian quadrature of Equation 14 (or another type of quadrature), where Q is the set of quadrilaterals in the mesh, and N_{qp} is the number of quadrature points with weights gᵢ and abscissae (sᵢ, tᵢ).

$${E}_{m} \approx \frac{h}{2} {\sum }_{q ∈ Q} {\sum }_{i = 0}^{{N}_{q p}} {g}_{i} {{ε}_{m} ( {s}_{i} , {t}_{i} )}^{T} K {ε}_{m} ( {s}_{i} , {t}_{i} ) ‖ \frac{\partial \overline{p}}{\partial s} ( {t}_{i} ) \times \frac{\partial \overline{p}}{\partial t} ( {s}_{i} ) ‖ \qquad Eqn . 14$$

At this point it is helpful to take the Taylor expansions of the tangents at the center of the patch:

$$\frac{\partial p}{\partial s} ( t ) = \frac{\partial p}{\partial s} ( \frac{1}{2} ) + ( \frac{1}{2} - t ) \frac{{\partial }^{2} p}{\partial s \partial t} \qquad Eqn . 15$$

$$\frac{\partial p}{\partial t} ( s ) = \frac{\partial p}{\partial t} ( \frac{1}{2} ) + ( \frac{1}{2} - s ) \frac{{\partial }^{2} p}{\partial s \partial t} \qquad Eqn . 16$$

This gives us a definition of the tangents as a linear combination of vectors that are constant per patch. U and V are linear functions of these vectors, so the entries of εₘ can be written as linear functions of their dot products. We omit the full formulas here for brevity, but this implies that we can expand εₘ as shown in Equations 17 and 18, where A_{q}(s, t) is a 3×7 matrix function, and Equation 18 is evaluated with all vectors evaluated at

$$( s , t ) = ( \frac{1}{2} , \frac{1}{2} ) .$$

$${ε}_{m} ( s , t ) = {A}_{q} ( s , t ) {\hat{ε}}_{m} \qquad Eqn . 17$$

$${\hat{ε}}_{m} = [ \begin{matrix}\begin{matrix}\begin{matrix}\begin{matrix}\begin{matrix}{\frac{\partial p}{\partial s}}^{T} \frac{\partial p}{\partial s} \\ {\frac{\partial p}{\partial s}}^{T} \frac{\partial p}{\partial t}\end{matrix} \\ {\frac{\partial p}{\partial t}}^{T} \frac{\partial p}{\partial t}\end{matrix} \\ {\frac{{\partial }^{2} p}{\partial s \partial t}}^{T} \frac{\partial p}{\partial s}\end{matrix} \\ {\frac{{\partial }^{2} p}{\partial s \partial t}}^{T} \frac{\partial p}{\partial t} \\ {\frac{{\partial }^{2} p}{\partial s \partial t}}^{T} \frac{{\partial }^{2} p}{\partial s \partial t}\end{matrix} \\ 1\end{matrix} ] \qquad Eqn . 18$$

Note that the final entry (the constant 1) isn't a strain, but it is needed in order to subtract 1 from the first two entries of εₘ, similar to how homogenous coordinates are used to translate points in transformation matrices. Since \hat{ε}ₘ no longer depends on st coordinates, we can move it outside of the sum over Gaussian quadrature points:

$${E}_{m} \approx \frac{h}{2} {\sum }_{q ∈ Q} {\hat{ε}}_{m}^{T} ( {\sum }_{i = 0}^{{N}_{q p}} {g}_{i} {{A}_{q} ( {s}_{i} , {t}_{i} )}^{T} K {A}_{q} ( {s}_{i} , {t}_{i} ) ‖ \frac{\partial \overline{p}}{\partial s} ( {t}_{i} ) \times \frac{\partial \overline{p}}{\partial t} ( {s}_{i} ) ‖ ) {\hat{ε}}_{m} \qquad Eqn . 19$$

It is now possible to evaluate the Gaussian quadrature sum with data known at the start of the simulation, i.e., rest positions, the stiffness matrix, and Gaussian quadrature weights. We use this to precompute a new 7×7 stiffness matrix \hat{K}_{q} per patch, resulting in our final membrane energy formula:

$${E}_{m} \approx \frac{h}{2} {\sum }_{q ∈ Q} {\hat{ε}}_{m}^{T} {\hat{K}}_{q} {\hat{ε}}_{m} \qquad Eqn . 20$$

We can now calculate the membrane energy over both triangles and bilinear patches, using 3 and 7 strain values respectively.

### Derivation of Bending Energy

In our framework, we use the following bending energy shown in Equation 21, where

S and S̅ are the shape operators for our current and rest surfaces respectively,

$${k}_{1} = \frac{E v}{1 - {v}^{2}} , and {k}_{2} = \frac{E ( 1 - v )}{1 - {v}^{2}} .$$

$${E}_{b} = \frac{{h}^{3}}{48} {\int }_{\overline{Ω}} {k}_{1} T {r ( S - \overline{S} )}^{2} + {k}_{2} T r ( {( S - \overline{S} )}^{2} ) d \overline{A} \qquad Eqn . 21$$

To calculate it on our discrete surface of triangles and quadrilaterals, we divide it into two parts: an in-element term that penalizes bending for each individual quadrilateral, and a cross-element term that penalizes bending between adjacent elements, assuming that each face is planar. We now discuss how to calculate both.

### In-Element Shape Operator.

For a parameterized surface, we can calculate the shape operator with the first and second fundamental forms, which are calculated from the first and second derivatives of the surface. For the bilinear patch, this gives the results of Equation 22 and Equation 23, where n is the normal of the surface.

$${S}_{q} = {[ \begin{matrix}0 & {\frac{{\partial }^{2} p}{\partial s \partial t}}^{T} n \\ {\frac{{\partial }^{2} p}{\partial s \partial t}}^{T} n & 0\end{matrix} ] [ \begin{matrix}{\frac{\partial p}{\partial s}}^{T} \frac{\partial p}{\partial s} & {\frac{\partial p}{\partial s}}^{T} \frac{\partial p}{\partial t} \\ {\frac{\partial p}{\partial s}}^{T} \frac{\partial p}{\partial t} & {\frac{\partial p}{\partial t}}^{T} \frac{\partial p}{\partial t}\end{matrix} ]}^{- 1} \qquad Eqn . 22$$

$$= \frac{{\frac{{\partial }^{2} p}{\partial s \partial t}}^{T} n}{{‖ \frac{\partial p}{\partial s} \times \frac{\partial p}{\partial t} ‖}^{2}} [ \begin{matrix}- {\frac{\partial p}{\partial s}}^{T} \frac{\partial p}{\partial t} & {\frac{\partial p}{\partial t}}^{T} \frac{\partial p}{\partial t} \\ {\frac{\partial p}{\partial s}}^{T} \frac{\partial p}{\partial s} & - {\frac{\partial p}{\partial s}}^{T} \frac{\partial p}{\partial t}\end{matrix} ] \qquad Eqn . 23$$

This is one definition of the shape operator, but it is not unique; we have chosen the tangents of the bilinear patch to be the basis for our tangent space, but we are free to choose a different basis instead. In fact, we should; subtracting shape operators as discussed above only makes sense if they use the same tangent space basis, and there is no guarantee that our bilinear patch tangents will be aligned between the rest positions and the current position. Therefore, we perform a change of basis: we orthonormalize the tangent space, keeping the direction of

$$\frac{\partial p}{\partial s}$$

consistent. We can do this by taking the QR decomposition of our tangent vectors and using the thin version of Q as our new basis. R then defines how to transform our shape operator. In summary:

$$[ \frac{\partial p}{\partial s} \vert \frac{\partial p}{\partial t} ] = QR \qquad Eqn . 24$$

$${\hat{S}}_{q} = R {S}_{q} {R}^{- 1} \qquad Eqn . 25$$

Note that there are multiple valid definitions of the reparameterized shape operator Ŝ_{q}, since the QR-decomposition is not unique, but all result in an equivalent bending energy. We choose the following definition:

$${\hat{S}}_{q} = \frac{{\frac{{\partial }^{2} p}{\partial s \partial t}}^{T} n}{{‖ \frac{\partial p}{\partial s} \times \frac{\partial p}{\partial t} ‖}^{2}} [ \begin{matrix}0 & ‖ \frac{\partial p}{\partial s} \times \frac{\partial p}{\partial t} ‖ \\ ‖ \frac{\partial p}{\partial s} \times \frac{\partial p}{\partial t} ‖ & - 2 {\frac{\partial p}{\partial s}}^{T} \frac{\partial p}{\partial t}\end{matrix} ] \qquad Eqn . 26$$

With this formulation, we can calculate the shape operators using the current and rest positions of each bilinear patch and subtract them without issue. We have found that calculating these shape operators once at the center of the patch is sufficient to approximate the energy integral.

### Cross-Element Shape Operator.

To measure bending across faces in a way that is consistent with our in-element shape operator, we calculate a discrete shape operator that assumes all faces are planar. De Goes et al. [De Goes 2020] describe how to calculate such a shape operator on a polygonal mesh. Their first formulation describes how to find the shape operator at the center of each face using surrounding vertex normals; however, each vertex normal depends on all of its adjacent faces, so the computational footprint for this calculation is fairly large. Instead, we opt for the adjoint version, which calculates a discrete shape operator for every vertex given the normals of the surrounding faces. This implies that the bending energy at a particular vertex depends on the surrounding 1-ring of vertices, which is consistent with the membrane energy.

The image processor might use a cross-element shape operator as shown in Equation 27, where v is the vertex where we are evaluating the shape operator, aᵥ is the voronoi area associated with vertex v, Tᵥ is an orthonormal tangent frame at vertex v, F (v) is the set of faces surrounding vertex v, Q_{f}^{v} is the linear operator that rotates the normal at f to the normal at v, g_{f}^{v} is the face area gradient vector, and n_{f} is the normal of the face.

$${S}_{v} = \frac{1}{2 {a}_{v}} {T}_{v}^{T} ( {\sum }_{f ∈ F ( v )} {Q}_{f}^{v} {g}_{f}^{v} {n}_{f}^{T} + {( {Q}_{f}^{v} {g}_{f}^{v} {n}_{f}^{T} )}^{T} ) {T}_{v} \qquad Eqn . 27$$

At a high level, this operator describes how much the normals at each face surrounding v need to be rotated to align with the vertex normal. We will now discuss how to compute each of these pieces in more detail.

For each face f, we calculate its area vector a_{f}, i.e., the vector in the direction of the face's normal with a length equal to its area. For quadrilateral elements, we calculate this as a_{f}=½ (p₀−p₂)×(p₁−p₃), and denote the planar area as α_{f}=∥a_{f}∥ and face normal as n_{f}=a_{f}/a_{f}. Note that

$${a}_{f} = \frac{\partial p}{\partial s} ( \frac{1}{2} ) \times \frac{\partial p}{\partial t} ( \frac{1}{2} ) ,$$

and that a_{f} is the area of the bilinear patch when projected to the tangent space at the center of the patch. Effectively, this is the closest linear approximation of the bilinear patch. Then, for each vertex v, we can compute its voronoi area as

$${a}_{v} = {\sum }_{f ∈ F ( v )} \frac{{a}_{f}}{{n}_{f}}$$

where n_{f} is the number of vertices of f, and the vertex normal as the normalized sum of surrounding face area vectors.

We define the gradient vector as g_{f}^{v}=½n_{f}×(pᵥ₋₁−pᵥ₊₁) where pᵥ₋₁ and pᵥ₊₁ denote the positions of vertices adjacent to v with respect to face f. (Note that this definition differs slightly from [De Goes et al. 2020] thanks to simplifications in our case.)

The vector tangent frame Tᵥ is arbitrary as long as it is consistent between the rest position and the current position. For every vertex, we deterministically choose an adjacent edge; we orthonormalize the vertex normal and this edge vector to construct a consistently oriented tangent basis.

### Anisotropic Stiffness

We can extend our definitions of membrane energies with anisotropic stiffness. In particular, we implement orthotropic stiffness, implying that separate Young's modulus values are specified along orthogonal directions in rest tangent space. We allow the user to specify uv-coordinates for each vertex, but unlike other frameworks, these coordinates do not specify the mapping to 2D material space, but rather its orientation—the rest space positions define the scale of material space. User-provided uv-coordinates may have some shearing that is not respected by the rest positions, so we prioritize aligning the u-axis in rest space with the provided coordinates, and choose the v-axis direction by enforcing orthonormality.

Suppose a user has specified uv-coordinates wᵢ for a triangle or bilinear element. We define a 2×2 basis from these coordinates, denoted W, calculated for triangles as in Equation 28, and for bilinear elements as in Equation 29.

$$W = [ ( {w}_{1} - {w}_{0} ) \vert ( {w}_{2} - {w}_{0} ) ] \qquad Eqn . 28$$

$$W ( s , t ) = [ \frac{\partial w}{\partial s} ( t ) \vert \frac{\partial w}{\partial t} ( s ) ] \qquad Eqn . 29$$

When calculating the membrane energy, we multiply the rest-space tangent basis by W⁻¹ before orthonormalizing, implying Q̅R̅=T̅W⁻¹. We must also take this into account when computing the deformation gradient: F=TW⁻¹R̅⁻¹.

### Energy Derivatives

Thus far, we've only discussed the deformation energies themselves, but we need their gradients with respect to the degrees of freedom to calculate forces, and their Hessians to build the system matrix used for implicit integration. Additionally, we would like to ensure that the Hessians can be made positive semi-definite to prevent instabilities when using Newton's method to perform implicit integration. We will now discuss the details of these derivatives.

With the assumption that our shape operators are symmetric (which we have ensured in the derivations above), each of our energies can be written as a sum of quadratic forms: E=½Σᵢεᵢ^{T}Kᵢεᵢ where i iterates over faces for the membrane or in-element bending energies, or vertices for the cross-element bending energy. In each of these cases, Kᵢ is independent of the degrees of freedom, so the gradient and Hessian of E can be written as follows:

$$\frac{\partial E}{\partial {p}_{j}} = {\sum }_{i} \frac{\partial {ε}_{i}}{\partial {p}_{j}} {K}_{i} {ε}_{i} \qquad Eqn . 30$$

$$\frac{{\partial }^{2} E}{\partial {p}_{j} \partial {p}_{k}} = {\sum }_{i} \frac{{\partial }^{2} {ε}_{i}}{\partial {p}_{j} \partial {p}_{k}} {K}_{i} {ε}_{i} + \frac{\partial {ε}_{i}}{\partial {p}_{j}} {K}_{i} {\frac{\partial {ε}_{i}}{\partial {p}_{k}}}^{T} \qquad Eqn . 31$$

This implies that we need to find derivatives with respect to our strains. For the membrane strains, this is straightforward, since all of our strain measures are quadratic expressions of our degrees of freedom, implying the Hessian tensor is constant. It has a simple structure of blocks of 3×3 scaled identity matrices, and it is straightforward to find the eigenvalues and eigenvectors. We keep either the positive semi-definite or negative semi-definite components based on the sign of the associated stress value to ensure that

$$\frac{{\partial }^{2} {ε}_{i}}{\partial {p}_{j} \partial {p}_{k}} {K}_{i} {ε}_{i}$$

is always positive semi-definite.

$$\frac{\partial {ε}_{i}}{\partial {p}_{j}} {K}_{i} {\frac{\partial {ε}_{i}}{\partial {p}_{k}}}^{T}$$

is positive semi-definite as long as Kᵢ is, which is always true in our system. The stress may be equal to the strain multiplied by the anisotropic stiffness of the material.

Our bending energy derivatives are significantly more complicated, but in our experiments we have found that it is sufficient to use a quasi-Newton approximation for these Hessians by omitting the second derivative of the strain. This is acceptable since the bending stiffness is generally small compared to the stretching stiffness for cloth and thin shells, and our time step sizes are largely limited by our collision algorithm.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

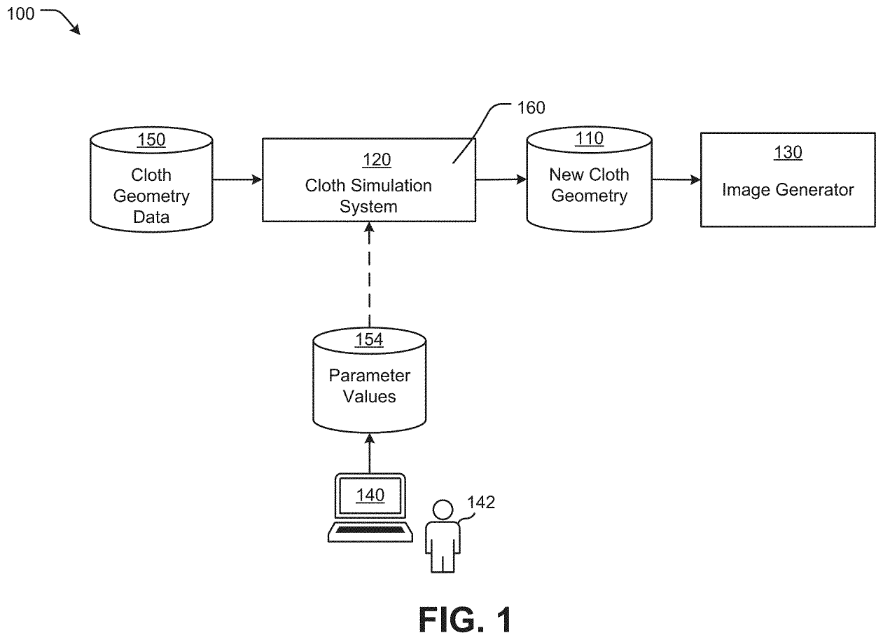

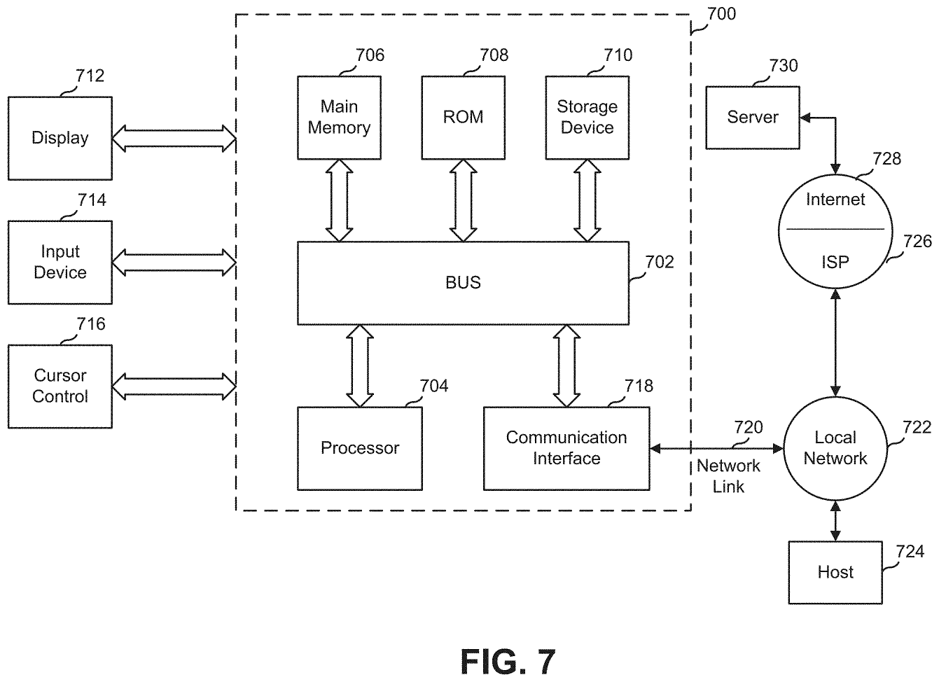

FIG. 1 is a schematic view, in block diagram form, of a simulation system 100, in accordance with at least one embodiment of the present disclosure. The system 100 includes a cloth simulation system 120 and at least one client computing device 140 operated by at least one human artist 142. The cloth simulation system 120 may be implemented by software executing on one or more computer systems (e.g., each like a computer system 700 illustrated in FIG. 7).

Cloth has been studied and simulated for engineering and scientific purposes. On the other hand, some computer graphics applications are concerned only with the appearance of cloth. Therefore, for such computer graphics applications, the cloth simulation system 120 is configured to generate a simplified cloth simulation that includes enough scientific calculations to generate a realistic looking cloth simulation but may employ models of limited accuracy, with resultant visual artifacts.

In some computer graphics applications, the cloth simulation system 120 can be configured to optimize computing efficiency by minimizing computational cycles to obtain the appearance of the cloth without including enough scientific calculations that would otherwise require for real world physical simulations. In other words, the cloth simulation system 120 is capable of reducing the number of parameters or variables in the simulation to obtain an appearance of the cloth and to produce a graphical representation of the cloth, rather than formulating detail calculations required, for example, for finite element simulation of the physical or kinetic properties of the cloth.

The cloth simulation system 120 is configured to receive cloth data 150 and user-defined parameter values 154 as input, and is configured to output multiple time points of the new cloth geometry 110, as other objects or substances interact with the cloth in the simulation. The cloth data 150 and/or the user-defined parameter values 154 may be stored by the cloth simulation system 120 and/or another device (e.g., a data storage) connected to the cloth simulation system 120. It should be understood that various elements being operated on, such as the values of the cloth properties 110, are stored as data that can be written to computer memory, read from computer memory, and transmitted between computer processes and/or components.

The cloth parameter values 154 may include any parameters that will affect the appearance of the cloth event. By way of non-limiting examples, the cloth parameter values 154 may include yarn thickness, yarn spacing, yarn stiffness, yarn elasticity, yarn color, yarn reflectivity, weave thickness, weave elasticity, weave direction(s), and other parameters related to the physical behavior of the cloth and/or its visual appearance.

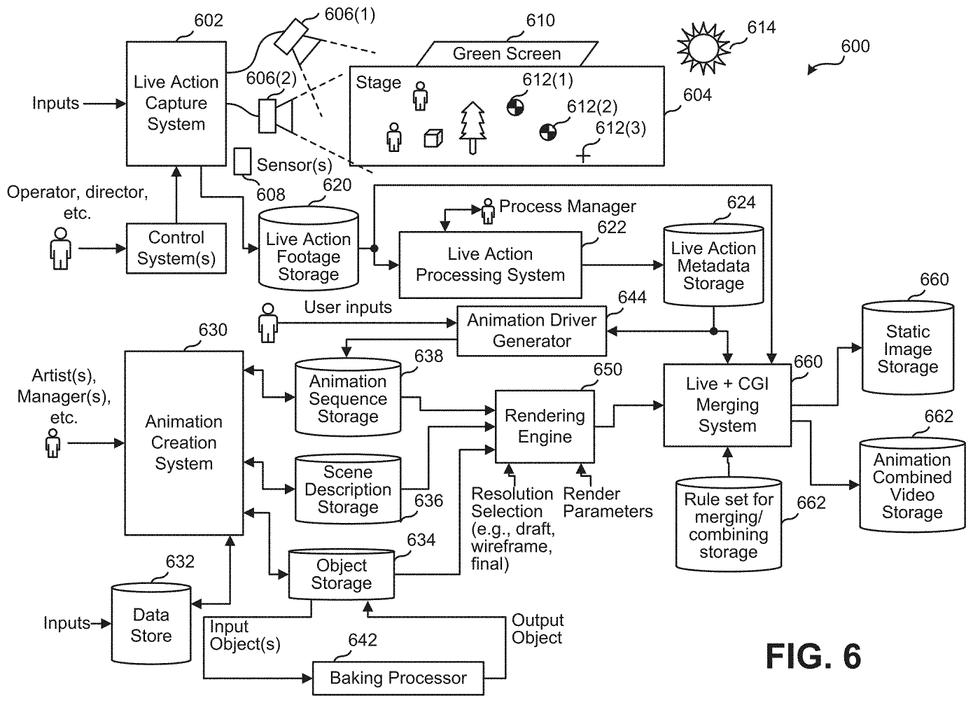

As described below, the visual content generation system 600 (see FIG. 6) is configured to receive the values of the cloth geometries 110 as input, and is configured to output one or more static images and/or one or more animated videos. The static image(s) and/or the animated video(s) include one or more visual representations of cloth created based at least in part on the values of the cloth geometries 110. The visual content generation system may transmit the static image(s) and/or the animated video(s) to the client computing device 140 for display to the artist 142. The artist 142 may use the static image(s) and/or the animated video(s) to view the visual representations of the cloth and make adjustments to the cloth parameter values 154. Then, the cloth simulation system 120 may output new values of the cloth properties 110, which the visual content generation system may use to output new versions of the static image(s) and/or the animated video(s) that may be viewed by the artist 142 on the client computing device 140. This process may be repeated until the artist 142 is satisfied with the appearance of the cloth in the static image(s) and/or the animated video(s). The client computing device 140 may be implemented using the computer system 700 illustrated in FIG. 7.

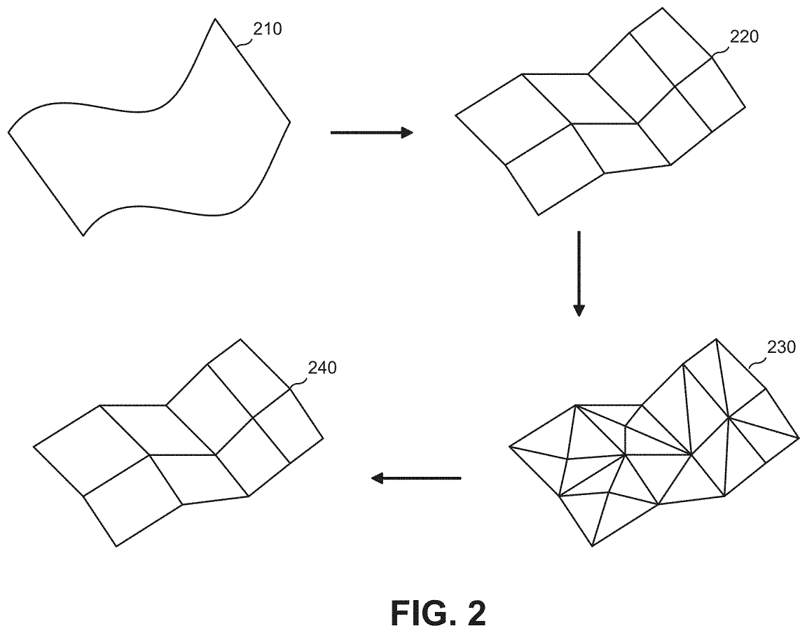

FIG. 2 shows a simplified exemplary process for simulating a piece of cloth, according to aspects of the present disclosure. The piece of cloth 210 is represented as a mesh 220 of rigid rectangles for modeling purposes, which is then converted to a mesh 230 of triangles for simulation purposes, and then converted back into a rectangular mesh 240 (in some cases, a mesh of rigid rectangles and in other cases a mesh of bilinear patches) for display purposes.

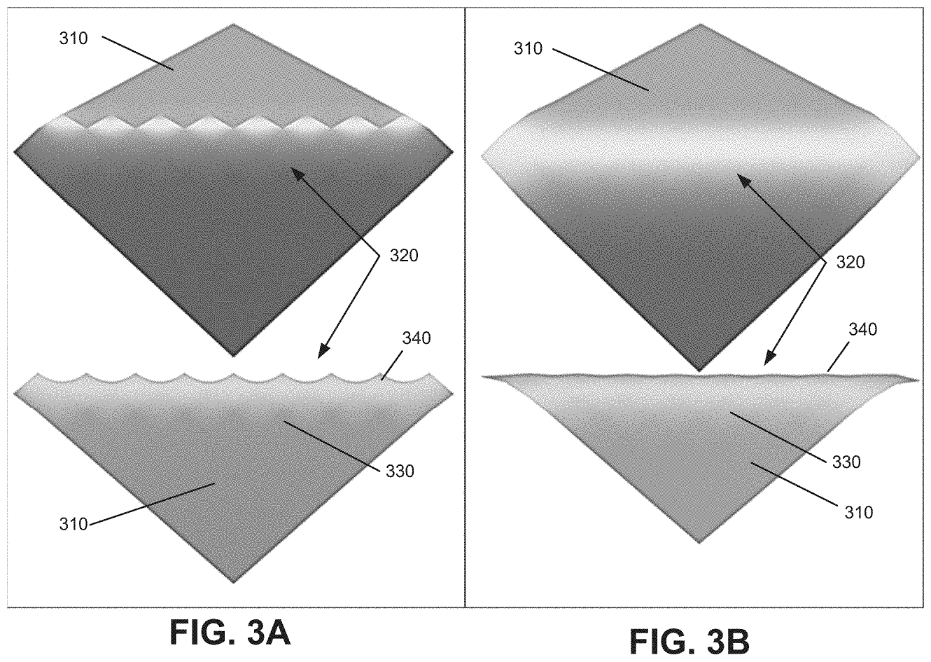

For visual effects and animation, the geometry used for cloth simulations is often subject to topology requirements from other stages of the production pipeline. Requests to simulate quadrilateral meshes are common, as these topologies are beneficial for modelling, subdivision, and rendering. However, most cloth simulation algorithms are defined only for triangle meshes. We may split quadrilaterals into triangles, or we may remesh the input geometry, but the output simulated mesh must have the same topology as the input in our pipeline. This means we must map the triangle displacements back to the original mesh, which can lead to faceting and tent-like artifacts from artificial curvature induced by the mapping (see FIG. 3).

FIG. 3A is an exemplary perspective view and side view representation of a piece of cloth 310 simulated via the process described in FIG. 2, or an equivalent process, according to aspects of the present disclosure. In this example, the cloth 310 includes an edge drape 320. As described above, simulating the cloth using a regular triangle grid, with displacements mapped to bilinear patches, results in faceting 330 and tent-like artifacts 340 in high curvature regions such as the edge drape 320. Such artifacts do not represent a physical behavior or appearance of natural cloth, and may thus be visually unconvincing and potentially distracting to viewers. It is therefore desirable to simulate the piece of cloth 310 by an alternative method that eliminates or reduces such artifacts.

FIG. 3B is an exemplary perspective view and side view representation of a piece of cloth 310 simulated according to at least one embodiment of the present disclosure. As can be seen from the FIG., simulating bilinear patches directly, rather than converting from a rectangular mesh to a triangular mesh and then to a mesh of bilinear patches, reduces the appearance of faceting 330 and tenting 340 along an edge drape 320. Reducing such artifacts gives the cloth 310 a more realistic (and thus potentially less distracting) appearance.

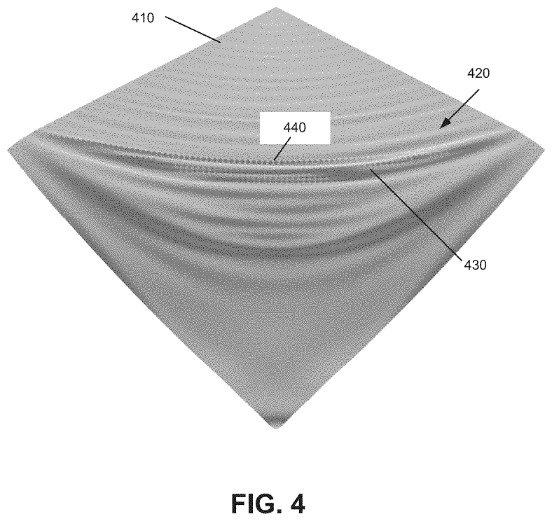

FIG. 4 is an exemplary perspective view of a piece of cloth 410 simulated via the process described in FIG. 2, or an equivalent process, according to aspects of the present disclosure. In this example, the cloth 410 includes an edge drape 420. As described above, simulating the cloth using a regular triangle grid, with displacements mapped to bilinear patches, results in faceting 430 and tent-like artifacts 440 in high curvature regions such as the edge drape 420.

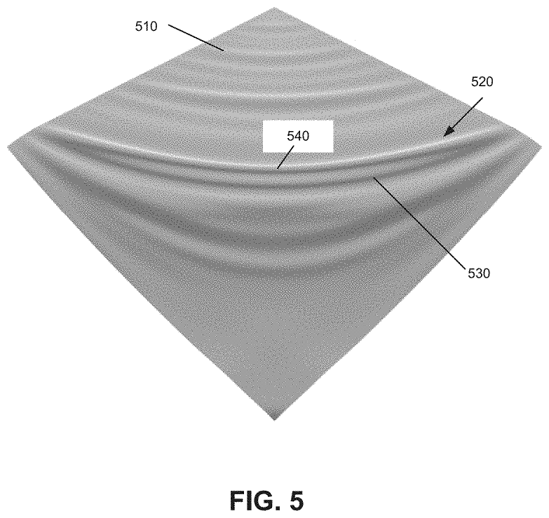

FIG. 5 is an exemplary perspective view of a piece of cloth 510 simulated according to at least one embodiment of the present disclosure. As can be seen from the FIG., in this particular case simulating bilinear patches directly, rather than converting from a rectangular mesh to a triangular mesh and then to a mesh of bilinear patches, reduces the appearance of faceting 530 and tenting 540 along an edge drape 520, such that the faceting and tenting artifacts are not visible at all. This gives the cloth 510 a more realistic appearance than the example of FIG. 4.

As will be readily appreciated by those having ordinary skill in the art after becoming familiar with the teachings herein, the present disclosure provides a framework for simulating cloth directly on quadrilateral meshes, or combined quadrilateral and triangular meshes. Simulating the nonlinear deformation of bilinear elements reduces faceting and tenting artifacts caused by geometric mappings. To handle collisions, the method described herein splits each quadrilateral into triangles for this stage. The systems and methods described herein are an important step forward for simulating arbitrary mesh topologies in production environments. Accordingly, it can be seen that the cloth simulation method fills a need in the art, by permitting more realistic cloth simulations without unduly increasing the computational burden.

A number of variations are possible on the examples and embodiments described above. For example, different types of cloth can be modeled than those shown herein, including thinner, thicker, heavier or denser, lighter, finer, or coarser cloths, or cloths with complex or alternative weaves or patterns (e.g., knit or embroidered patterns). The technology described herein may be applied not only for visual effects, but also for simulating cloth for a variety of engineering, scientific, design, or aesthetic purposes. For example, a clothing designer may use the techniques described herein to explore how different fabrics will appear on wearers of different sizes or builds.

FIG. 6 illustrates an example visual content generation system 600 usable for implementing a cloth simulation system to provide for visually appealing simulations, in accordance with at least one embodiment of the present disclosure. For example, the visual content generation system 600 might be used to generate imagery in the form of still images and/or video sequences of images. Visual content generation system 600 might generate imagery of live action scenes, computer generated scenes, or a combination thereof. In a practical system, users are provided with tools that allow them to specify, at high levels and low levels where necessary, what is to go into that imagery. For example, a user might be an animation artist and might use visual content generation system 600 to capture interaction between two human actors performing live on a sound stage and replace one of the human actors with a computer-generated anthropomorphic non-human being that behaves in ways that mimic the replaced human actor's movements and mannerisms, and then add in a third computer-generated character and background scene elements that are computer-generated, all in order to tell a desired story or generate desired imagery.

Still images that are output by visual content generation system 600 might be represented in computer memory as pixel arrays, such as a two-dimensional array of pixel color values, each associated with a pixel having a position in a two-dimensional image array. Pixel color values might be represented by three or more (or fewer) color values per pixel, such as a red value, a green value, and a blue value (e.g., in RGB format). Dimensions of such a two-dimensional array of pixel color values might correspond to a preferred and/or standard display scheme, such as 1920-pixel columns by 1280-pixel rows or 4096-pixel columns by 2160-pixel rows, or some other resolution. Images might or might not be stored in a certain structured format, but either way, a desired image may be represented as a two-dimensional array of pixel color values. In another variation, images are represented by a pair of stereo images for three-dimensional presentations and in other variations, an image output, or a portion thereof, might represent three-dimensional imagery instead of just two-dimensional views. In yet other embodiments, pixel values are data structures and a pixel value can be associated with a pixel and can be a scalar value, a vector, or another data structure associated with a corresponding pixel. That pixel value might include color values, or not, and might include depth values, alpha values, weight values, object identifiers or other pixel value components.

A stored video sequence might include a plurality of images such as the still images described above, but where each image of the plurality of images has a place in a timing sequence and the stored video sequence is arranged so that when each image is displayed in order, at a time indicated by the timing sequence, the display presents what appears to be moving and/or changing imagery. In one representation, each image of the plurality of images is a video frame having a specified frame number that corresponds to an amount of time that would elapse from when a video sequence begins playing until that specified frame is displayed. A frame rate might be used to describe how many frames of the stored video sequence are displayed per unit time. Example video sequences might include 24 frames per second (24 FPS), 50 FPS, 140 FPS, or other frame rates. In some embodiments, frames are interlaced or otherwise presented for display, but for clarity of description, in some examples, it is assumed that a video frame has one specified display time, but other variations might be contemplated.

One method of creating a video sequence is to simply use a video camera to record a live action scene, i.e., events that physically occur and can be recorded by a video camera. The events being recorded can be events to be interpreted as viewed (such as seeing two human actors talk to each other) and/or can include events to be interpreted differently due to clever camera operations (such as moving actors about a stage to make one appear larger than the other despite the actors actually being of similar build, or using miniature objects with other miniature objects so as to be interpreted as a scene containing life-sized objects).

Creating video sequences for story-telling or other purposes often calls for scenes that cannot be created with live actors, such as a talking tree, an anthropomorphic object, space battles, and the like. Such video sequences might be generated computationally rather than capturing light from live scenes. In some instances, an entirety of a video sequence might be generated computationally, as in the case of a computer-animated feature film. In some video sequences, it is desirable to have some computer-generated imagery and some live action, perhaps with some careful merging of the two.

While computer-generated imagery might be creatable by manually specifying each color value for each pixel in each frame, this is likely too tedious to be practical. As a result, a creator uses various tools to specify the imagery at a higher level. As an example, an artist might specify the positions in a scene space, such as a three-dimensional coordinate system, of objects and/or lighting, as well as a camera viewpoint, and a camera view plane. From that, a rendering engine could take all of those as inputs, and compute each of the pixel color values in each of the frames. In another example, an artist specifies position and movement of an articulated object having some specified texture rather than specifying the color of each pixel representing that articulated object in each frame.

In a specific example, a rendering engine performs ray tracing wherein a pixel color value is determined by computing which objects lie along a ray traced in the scene space from the camera viewpoint through a point or portion of the camera view plane that corresponds to that pixel. For example, a camera view plane might be represented as a rectangle having a position in the scene space that is divided into a grid corresponding to the pixels of the ultimate image to be generated, and if a ray defined by the camera viewpoint in the scene space and a given pixel in that grid first intersects a solid, opaque, blue object, that given pixel is assigned the color blue. Of course, for modern computer-generated imagery, determining pixel colors—and thereby generating imagery—can be more complicated, as there are lighting issues, reflections, interpolations, and other considerations.

As illustrated in FIG. 6, a live action capture system 602 captures a live scene that plays out on a stage 604. Live action capture system 602 is described herein in greater detail, but might include computer processing capabilities, image processing capabilities, one or more processors, program code storage for storing program instructions executable by the one or more processors, as well as user input devices and user output devices, not all of which are shown.

In a specific live action capture system, cameras 606(1) and 606(2) capture the scene, while in some systems, there might be other sensor(s) 608 that capture information from the live scene (e.g., infrared cameras, infrared sensors, motion capture (“mo-cap”) detectors, etc.). On stage 604, there might be human actors, animal actors, inanimate objects, background objects, and possibly an object such as a green screen 610 that is designed to be captured in a live scene recording in such a way that it is easily overlaid with computer-generated imagery. Stage 604 might also contain objects that serve as fiducials, such as fiducials 612(1)-(3), that might be used post-capture to determine where an object was during capture. A live action scene might be illuminated by one or more lights, such as an overhead light 614.

During or following the capture of a live action scene, live action capture system 602 might output live action footage to a live action footage storage 620. A live action processing system 622 might process live action footage to generate data about that live action footage and store that data into a live action metadata storage 624. Live action processing system 622 might include computer processing capabilities, image processing capabilities, one or more processors, program code storage for storing program instructions executable by the one or more processors, as well as user input devices and user output devices, not all of which are shown. Live action processing system 622 might process live action footage to determine boundaries of objects in a frame or multiple frames, determine locations of objects in a live action scene, where a camera was relative to some action, distances between moving objects and fiducials, etc. Where elements have sensors attached to them or are detected, the metadata might include location, color, and intensity of overhead light 614, as that might be useful in post-processing to match computer-generated lighting on objects that are computer-generated and overlaid on the live action footage. Live action processing system 622 might operate autonomously, perhaps based on predetermined program instructions, to generate and output the live action metadata upon receiving and inputting the live action footage. The live action footage can be camera-captured data as well as data from other sensors.

An animation creation system 630 is another part of visual content generation system 600. Animation creation system 630 might include computer processing capabilities, image processing capabilities, one or more processors, program code storage for storing program instructions executable by the one or more processors, as well as user input devices and user output devices, not all of which are shown. Animation creation system 630 might be used by animation artists, managers, and others to specify details, perhaps programmatically and/or interactively, of imagery to be generated. From user input and data from a database or other data source, indicated as a data store 632, animation creation system 630 might generate and output data representing objects (e.g., a horse, a human, a ball, a teapot, a cloud, a light source, a texture, etc.) to an object storage 634, generate and output data representing a scene into a scene description storage 636, and/or generate and output data representing animation sequences to an animation sequence storage 638.

Scene data might indicate locations of objects and other visual elements, values of their parameters, lighting, camera location, camera view plane, and other details that a rendering engine 650 might use to render CGI imagery. For example, scene data might include the locations of several articulated characters, background objects, lighting, etc. specified in a two-dimensional space, three-dimensional space, or other dimensional space (such as a 2.5-dimensional space, three-quarter dimensions, pseudo-3D spaces, etc.) along with locations of a camera viewpoint and view place from which to render imagery. For example, scene data might indicate that there is to be a red, fuzzy, talking dog in the right half of a video and a stationary tree in the left half of the video, all illuminated by a bright point light source that is above and behind the camera viewpoint. In some cases, the camera viewpoint is not explicit, but can be determined from a viewing frustum. In the case of imagery that is to be rendered to a rectangular view, the frustum would be a truncated pyramid. Other shapes for a rendered view are possible and the camera view plane could be different for different shapes.

Animation creation system 630 might be interactive, allowing a user to read in animation sequences, scene descriptions, object details, etc. and edit those, possibly returning them to storage to update or replace existing data. As an example, an operator might read in objects from object storage into a baking processor 642 that would transform those objects into simpler forms and return those to object storage 634 as new or different objects. For example, an operator might read in an object that has dozens of specified parameters (movable joints, color options, textures, etc.), select some values for those parameters and then save a baked object that is a simplified object with now fixed values for those parameters.

Rather than requiring user specification of each detail of a scene, data from data store 632 might be used to drive object presentation. For example, if an artist is creating an animation of a spaceship passing over the surface of the Earth, instead of manually drawing or specifying a coastline, the artist might specify that animation creation system 630 is to read data from data store 632 in a file containing coordinates of Earth coastlines and generate background elements of a scene using that coastline data.

Animation sequence data might be in the form of time series of data for control points of an object that has attributes that are controllable. For example, an object might be a humanoid character with limbs and joints that are movable in manners similar to typical human movements. An artist can specify an animation sequence at a high level, such as “the left hand moves from location (X1, Y1, Z1) to (X2, Y2, Z2) over time T1 to T2”, at a lower level (e.g., “move the elbow joint 2.5 degrees per frame”) or even at a very high level (e.g., “character A should move, consistent with the laws of physics that are given for this scene, from point P1 to point P2 along a specified path”).

Animation sequences in an animated scene might be specified by what happens in a live action scene. An animation driver generator 644 might read in live action metadata, such as data representing movements and positions of body parts of a live actor during a live action scene. Animation driver generator 644 might generate corresponding animation parameters to be stored in animation sequence storage 638 for use in animating a CGI object. This can be useful where a live action scene of a human actor is captured while wearing mo-cap fiducials (e.g., high-contrast markers outside actor clothing, high-visibility paint on actor skin, face, etc.) and the movement of those fiducials is determined by live action processing system 622. Animation driver generator 644 might convert that movement data into specifications of how joints of an articulated CGI character are to move over time.

A rendering engine 650 can read in animation sequences, scene descriptions, and object details, as well as rendering engine control inputs, such as a resolution selection and a set of rendering parameters. Resolution selection might be useful for an operator to control a trade-off between speed of rendering and clarity of detail, as speed might be more important than clarity for a movie maker to test some interaction or direction, while clarity might be more important than speed for a movie maker to generate data that will be used for final prints of feature films to be distributed. Rendering engine 650 might include computer processing capabilities, image processing capabilities, one or more processors, program code storage for storing program instructions executable by the one or more processors, as well as user input devices and user output devices, not all of which are shown.

Visual content generation system 600 can also include a merging system 660 that merges live footage with animated content. The live footage might be obtained and input by reading from live action footage storage 620 to obtain live action footage, by reading from live action metadata storage 624 to obtain details such as presumed segmentation in captured images segmenting objects in a live action scene from their background (perhaps aided by the fact that green screen 610 was part of the live action scene), and by obtaining CGI imagery from rendering engine 650.

A merging system 660 might also read data from rulesets for merging/combining storage 662. A very simple example of a rule in a ruleset might be “obtain a full image including a two-dimensional pixel array from live footage, obtain a full image including a two-dimensional pixel array from rendering engine 650, and output an image where each pixel is a corresponding pixel from rendering engine 650 when the corresponding pixel in the live footage is a specific color of green, otherwise output a pixel value from the corresponding pixel in the live footage.”

Merging system 660 might include computer processing capabilities, image processing capabilities, one or more processors, program code storage for storing program instructions executable by the one or more processors, as well as user input devices and user output devices, not all of which are shown. Merging system 660 might operate autonomously, following programming instructions, or might have a user interface or programmatic interface over which an operator can control a merging process. In some embodiments, an operator can specify parameter values to use in a merging process and/or might specify specific tweaks to be made to an output of merging system 660, such as modifying boundaries of segmented objects, inserting blurs to smooth out imperfections, or adding other effects. Based on its inputs, merging system 660 can output an image to be stored in a static image storage 670 and/or a sequence of images in the form of video to be stored in an animated/combined video storage 672.

Thus, as described, visual content generation system 600 can be used to generate video that combines live action with computer-generated animation using various components and tools, some of which are described in more detail herein. While visual content generation system 600 might be useful for such combinations, with suitable settings, it can be used for outputting entirely live action footage or entirely CGI sequences. The code may also be provided and/or carried by a transitory computer readable medium, e.g., a transmission medium such as in the form of a signal transmitted over a network.

According to one embodiment, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One embodiment might include a carrier medium carrying image data or other data having details generated using the methods described herein. The carrier medium can comprise any medium suitable for carrying the image data or other data, including a storage medium, e.g., solid-state memory, an optical disk or a magnetic disk, or a transient medium, e.g., a signal carrying the image data such as a signal transmitted over a network, a digital signal, a radio frequency signal, an acoustic signal, an optical signal or an electrical signal.

FIG. 7 is a block diagram that illustrates a computer system 700 upon which the computer systems of the systems described herein and/or visual content generation system 600 (see FIG. 6) may be implemented. Computer system 700 includes a bus 702 or other communication mechanism for communicating information, and a processor 704 coupled with bus 702 for processing information. Processor 704 may be, for example, a general-purpose microprocessor.

Computer system 700 also includes a main memory 706, such as a random-access memory (RAM) or other dynamic storage device, coupled to bus 702 for storing information and instructions to be executed by processor 704. Main memory 706 may also be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a computer monitor, for displaying information to a computer user. An input device 714, including alphanumeric and other keys, is coupled to bus 702 for communicating information and command selections to processor 704. Another type of user input device is a cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a network connection. A modem or network interface local to computer system 700 can receive the data. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be a network card, a modem, a cable modem, or a satellite modem to provide a data communication connection to a corresponding type of telephone line or communications line. Wireless links may also be implemented. In any such implementation, communication interface 718 sends and receives electrical, electromagnetic, or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world-wide packet data communication network now commonly referred to as the “Internet” 728. Local network 722 and Internet 728 both use electrical, electromagnetic, or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720, and communication interface 718. In the Internet example, a server 730 might transmit a requested code for an application program through the Internet 728, ISP 726, local network 722, and communication interface 718. The received code may be executed by processor 704 as it is received, and/or stored in storage device 710, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be provided carried by a transitory computer readable medium e.g., a transmission medium such as in the form of a signal transmitted over a network.

Logical operations making up the embodiments of the technology described herein are referred to variously as operations, steps, objects, elements, equations, components, or modules. Directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the cloth simulation method. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

The following numbered examples are embodiments.

1. A computer implemented method for simulating a flexible material, the method comprising:
generating a mesh data structure representing the flexible material with a mesh, the mesh comprising at least one bilinear quadrilateral mesh element, wherein the mesh data structure specifies a specified number of degrees of freedom per vertex of the at least one bilinear quadrilateral mesh element;
computing a per-element deformation strain value for at least one bilinear quadrilateral mesh element of the at least one quadrilinear mesh element, wherein the per-element deformation strain value depends on a second order function with respect to the specified number of degrees of freedom of vertices of the at least one bilinear quadrilateral mesh element; and
simulating a motion of the flexible material using at least per-element deformation strains of each mesh element of the mesh to simulate motion of the vertices of mesh elements along the specified number degrees of freedom of their respective vertices.

2. The computer-implemented method of example 1, wherein the specified number of degrees of freedom per vertex is three.

3. The computer-implemented method of example 1 or example 2, wherein the mesh comprises no more than one quadrature point per mesh element.

4. The computer-implemented method of any one of examples 1 to 3, wherein at least one bilinear quadrilateral mesh element of the at least one bilinear quadrilateral mesh element is non-planar.

5. The computer-implemented method of any one of examples 1 to 4, wherein the mesh additionally comprises at least one triangular mesh element.

6. The computer-implemented method of example 3, wherein edge orientations of the at least one quadrilateral mesh element and the at least one triangular mesh element are independent of a substructure of the flexible material.

7. The computer-implemented method of any one of examples 1 to 6, further comprising representing the flexible material with a second mesh, wherein the second mesh represents a non-planar rest state of the flexible material.

8. The computer-implemented method of any one of examples 1 to 7, wherein the per-element deformation stresses associated with the per-element deformation strains represent an anisotropic stiffness of the material.

9. The computer-implemented method of any one of examples 1 to 8, wherein the anisotropic stiffness increases as a function of the per-element deformation strains and has no negative derivative anywhere on the mesh.

10. The computer-implemented method of any one of examples 1 to 9, wherein simulating the motion of the flexible material includes simulating viscous damping of the motion.

11. The computer-implemented method of any one of examples 1 to 10, wherein the mesh data structure is derived directly from a mesh received from an artist tool and represents a topology of the flexible material developed by the artist.

12. The computer-implemented method of example 12, wherein simulating the motion of the flexible material does not require remeshing of the at least one bilinear quadrilateral mesh element into at least one triangular mesh element.

13. The computer-implemented method of any one of examples 1 to 12, wherein the mesh is associated with a positive definite energy Hessian.

14. The computer-implemented method of any one of examples 1 to 13, wherein a deformation energy of the mesh comprises:
a membrane deformation energy comprising in-plane stretch energy and in-plane and shear energy; and
a bending deformation energy comprising in-element bending energies and cross-element bending energies for each mesh element.

15. The computer-implemented method of example 14, wherein the deformation energy of the mesh further comprises gradients of the membrane deformation energy and bending deformation energy.

16. The computer-implemented method of any one of examples 1 to 15, wherein a thickness of the flexible material is less than 5% of a length and breadth of the flexible material.

17. The computer-implemented method of example 16, wherein the thickness of the flexible material is constant.

18. The computer-implemented method of example 17, wherein the flexible material comprises cloth, paper, rubber, plastic, feathers, or leaves.

19. A computer implemented method for simulating a flexible material, the method comprising:
generating a mesh data structure representing the flexible material with a mesh comprising at least one non-planar bilinear quadrilateral mesh element, wherein each mesh element of the at least one non-planar bilinear quadrilateral mesh element comprises a single quadrature point and no additional quadrature points;
computing a deformation strain value that is second order with respect to the degrees of freedom of vertices of the at least one quadrilateral mesh element; and
simulating motion of the cloth by simulating motion of vertices of each mesh element along the three degrees of freedom of the respective vertex.

20. A computer-implemented method for generating an animated image comprising the method according to the method of any one of examples 1 to 19 and rendering an animated image using the simulated motion of the simulated flexible material.

21. A non-transitory computer-readable storage medium storing instructions, which when executed by at least one processor of a computer system, causes the computer system to carry out the method of any one of examples 1 to 20.

22. A computer-readable medium carrying instructions, which when executed by at least one processor of a computer system, causes the computer system to carry out the method of any one of examples 1 to 20.

23. A computer system comprising:
one or more processors; and
a storage medium storing instructions, which when executed by the at least one processor, cause the system to implement the method of any one of examples 1 to 20.

24. A carrier medium carrying image data that includes pixel information generated according to the method of any one of examples 1 to 20.

What is claimed is:

1. A computer implemented method for simulating a flexible material, the method comprising:
generating a mesh data structure representing the flexible material with a mesh, the mesh comprising at least one bilinear quadrilateral mesh element, wherein the mesh data structure specifies a specified number of degrees of freedom per vertex of the at least one bilinear quadrilateral mesh element;
computing a per-element deformation strain value for at least one bilinear quadrilateral mesh element of the at least one quadrilinear mesh element, wherein the per-element deformation strain value depends on a second order function with respect to the specified number of degrees of freedom of vertices of the at least one bilinear quadrilateral mesh element; and
simulating a motion of the flexible material using at least per-element deformation strains of each mesh element of the mesh to simulate motion of the vertices of mesh elements along the specified number degrees of freedom of their respective vertices.

2. The computer-implemented method of claim 1, wherein the specified number of degrees of freedom per vertex is three.

3. The computer-implemented method of claim 1, wherein the mesh comprises no more than one quadrature point per mesh element.

4. The computer-implemented method of claim 1, wherein at least one bilinear quadrilateral mesh element of the at least one bilinear quadrilateral mesh element is non-planar.

5. The computer-implemented method of claim 1, wherein the mesh additionally comprises at least one triangular mesh element.

6. The computer-implemented method of claim 3, wherein edge orientations of the at least one quadrilateral mesh element and the at least one triangular mesh element are independent of a substructure of the flexible material.

7. The computer-implemented method of claim 1, further comprising representing the flexible material with a second mesh, wherein the second mesh represents a non-planar rest state of the flexible material.

8. The computer-implemented method of claim 1, wherein per-element deformation stresses associated with the per-element deformation strains represent an anisotropic stiffness of the material.

9. The computer-implemented method of claim 1, wherein the anisotropic stiffness increases as a function of the per-element deformation strains and has no negative derivative anywhere on the mesh.

10. The computer-implemented method of claim 1, wherein simulating the motion of the flexible material includes simulating viscous damping of the motion.

11. The computer-implemented method of claim 1, wherein the mesh data structure is derived directly from a mesh received from an artist tool and represents a topology of the flexible material developed by the artist.

12. The computer-implemented method of claim 1, wherein simulating the motion of the flexible material does not require remeshing of the at least one bilinear quadrilateral mesh element into at least one triangular mesh element.

13. The computer-implemented method of claim 1, wherein the mesh is associated with a positive definite energy Hessian.

14. The computer-implemented method of claim 1, wherein a deformation energy of the mesh comprises:
a membrane deformation energy comprising in-plane stretch energy and in-plane and shear energy; and
a bending deformation energy comprising in-element bending energies and cross-element bending energies for each mesh element.

15. The computer-implemented method of claim 14, wherein the deformation energy of the mesh further comprises gradients of the membrane deformation energy and bending deformation energy.

16. The computer-implemented method of claim 1, wherein a thickness of the flexible material is less than 5% of a length and breadth of the flexible material.

17. The computer-implemented method of claim 16, wherein the thickness of the flexible material is constant.

18. The computer-implemented method of claim 17, wherein the flexible material comprises cloth, paper, rubber, plastic, feathers, or leaves.

19. A computer implemented method for simulating a flexible material, the method comprising:
generating a mesh data structure representing the flexible material with a mesh comprising at least one non-planar bilinear quadrilateral mesh element, wherein each mesh element of the at least one non-planar bilinear quadrilateral mesh element comprises a single quadrature point and no additional quadrature points;
computing a deformation strain value that is second order with respect to the degrees of freedom of vertices of the at least one quadrilateral mesh element; and
simulating motion of the cloth by simulating motion of vertices of each mesh element along the three degrees of freedom of the respective vertex.

20. A computer-implemented method for generating an animated image comprising the method according to the method of claim 1 and rendering an animated image using the simulated motion of the simulated flexible material.

21. A non-transitory computer-readable storage medium storing instructions, which when executed by at least one processor of a computer system, causes the computer system to carry out the method of claim 1.

22. A computer-readable medium carrying instructions, which when executed by at least one processor of a computer system, causes the computer system to carry out the method of claim 1.

23. A computer system comprising:
one or more processors; and
a storage medium storing instructions, which when executed by the at least one processor, cause the system to implement the method of claim 1.

23. A carrier medium carrying image data that includes pixel information generated according to the method of any one of claim 1.
